(19) United States
(12) Patent Application Publication
(10) Pub. No.: US 2013/0282803 A1
(43) Pub. Date: Oct. 24, 2013

(54) ENGAGING SESSION ELEMENTS IN CONFERENCE SESSIONS

(71) Applicants: Marc Boyer, Bellevue, WA (US); Lamont James, Seattle, WA (US); Rama Krishna Pagadala, Redmond, WA (US); Amit Sehgal, Redmond, WA (US)

(72) Inventors: Marc Boyer, Bellevue, WA (US); Lamont James, Seattle, WA (US); Rama Krishna Pagadala, Redmond, WA (US); Amit Sehgal, Redmond, WA (US)

(73) Assignee: MICROSOFT CORPORATION, Redmond, WA (US)

(21) Appl. No.: 13/450,038

(22) Filed: Apr. 18, 2012

(51) Int. Cl. G06F 15/16

(52) U.S. Cl. 709/204

(57) ABSTRACT

Provided herein are systems, methods, and software for facilitating conference sessions. In particular, implementations disclosed herein pertain to engaging session elements using both a primary identifier and a secondary identifier included in a request to join a user to a session. A primary session element may be engaged using the primary identifier while a secondary session element may be engaged using the secondary identifier.

### TECHNICAL FIELD

Aspects of the disclosure are related to conference systems, and in particular to technologies for engaging a variety of session elements in conference sessions.

### TECHNICAL BACKGROUND

Conferencing system and technologies allow participants to interact with each other in a variety of ways. Many conferencing systems not only allow users to exchange voice communications with one another, but some also include enhanced features such as chat capabilities, document exchange, streaming video, and other types of data. Participants may access conference sessions using a variety of communication devices and by way of a variety of communication channels.

For example, a participant may login into a conference session and enjoy multi-modal participation in the session. The participant can speak on the session while also communicating with others via chat, texting, or video exchange. In such a case, the participant is usually identified correctly on the session roster to the other session participants by his login identity. At times, a participant may be relegated to dialing into a conference session from a phone not recognized by the conference system. In such a case, in such a case, the participant may be identified on the roster by a calling phone number. This presentation of the participant's identity could prove confusing or otherwise sub-optimal for the participant or other participants in the session.

Additional confusion may be created should the participant login to the conference session while also calling in via a separate voice call, resulting in duplicate identities in the roster. This situation may result in the participant being identified as two participants: once by his login identify and a second instance by a calling number.

### OVERVIEW

Provided herein are systems, methods, and software for facilitating conference sessions. In particular, implementations disclosed herein pertain to engaging session elements using both a primary identifier and a secondary identifier included in a request to join a user to a session. A primary session element may be engaged using the primary identifier while a secondary session element may be engaged using the secondary identifier. This may allow, for example, a user to be registered using the primary identifier while participating in a conference session by way of the secondary session element. In some cases, the user may participate using both session elements or may even participate using additional session elements.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a conferencing environment in an implementation.

FIG. 2 illustrates operations of a communication system in an implementation.

FIG. 3 illustrates a computing system in an implementation.

FIG. 4 illustrates a conferencing environment in an implementation.

FIG. 5 illustrates a client device in an implementation, as well as several graphical views and a join request in the implementation.

FIG. 6 illustrates a client device in an implementation, as well as a session view in the implementation.

FIG. 7 illustrates a conference flow diagram in an implementation.

FIG. 8 illustrates a conference flow diagram in an implementation.

FIG. 9 illustrates a conference flow diagram in an implementation.

FIG. 10 illustrates a conference flow diagram in an implementation.

### TECHNICAL DISCLOSURE

Implementations described herein provide for improved conferencing by providing at least a primary and a secondary identifier in a request to join a user to a conference session. Primary and secondary elements associated with the primary and secondary identifiers respectively may be engaged using the primary and secondary identifiers. Optionally, a third, fourth, or even more identifiers may be included in the request and additional session elements engaged accordingly.

In a brief example, a user operating a client communication device, such as a mobile phone, a tablet computer, a personal computer, or any other type of computing appliance or device, interacts with a conferencing application to join a conference session. A variety of conference applications are available to provide this functionality, such as unified communication clients, email clients, messaging clients, and any combination or variation thereof. The conference session may be a voice conference, but may also involve other types of communication exchange, such as messaging, video, or other data exchange.

To join the conference call, the conferencing application in concert with the client communication generates and transfers a request for delivery to a conference system to join the requesting user to the conference session. Among many possible items, a primary and secondary identifier can be included in the request. In this example, the primary identifier is a login identifier associated with the requesting user and the secondary identifier is a call back number. The login identifier is processed by the conference system to grant access to the requesting user. The call back number is used to initiate a call back to engage the requesting user in the conference session.

The call back may be placed to the client communication device from which the request is originated. In this case, the requesting user can answer the call and participate in the conference session by way of exchanging voice communications over the call. Since the user is also logged into the conference and granted access based on the login identifier, the user may be able to, in addition to exchanging voice communications, exchange data communications in the conference session. For instance, the conferencing application running on the client communication device may provide messaging functionality that allows the user to engage in chat sessions with other participants in the conference session.

The user can view the identities of the other participants on the conference. For example, the login identities provided by the other participants when they too logged into the conference session may be displayed to the user.

Note that the identity of the requesting user may also be provided to the other participants. Since the requesting user logged in under an identity, that identity can be provided and displayed to the other participants. By also joining via a voice call back from the conference system, the data communications provided by the user can be joined with the voice communications for presentation purpose to the other users. In other words, the conference system can correctly identify the voice call and the data communications with the requesting user because both identifiers—the login identity and the call back number—were included in the request to join the user to the conference session.

It should be understood that a variety of alternative scenarios could be implemented without departing from the scope of the disclosure contemplated herein. For example, rather than identifying a call back number in the request to join the session, a caller number or caller identifier may be included. This caller number may be associated with any calling device capable of calling into the conference session. Thus, the user can specify a particular number from which he or she may access the conference session. In this manner, the conference system need not store a predefined list of caller identifier in association with conference participants. While the caller identifier may be that of the client communication device used to generate the request to join the session, the caller identifier may be associated with some other calling device, such as a nearby telephone with which the user can call into the session. Optionally, both the call back number and the caller number can be provided in the request to join the conference to provide the user with flexibility in reaching the conference session.

In another alternative, the secondary identifier may be a link or some other suitable identifier associated with media to present in the conference session. For example, a uniform resource locator (URL) address associated with video stored on a video server can be included in the request. Upon receiving the request, the conference system can integrate the video into the conference session and present the video to the participants.

In fact, many different types of media or content may be integrated into a conference session in this manner. For example, the secondary identifier may be a network address of a suitable media device, such as a camera, from which content may be streamed to the conference server and integrated into the conference session.

In both examples, the content may be presented as associated with the requesting user. In other words, by providing the link in the request to join the user to the session, the conference session is able to present the content to the other participants as associated with the requesting participant.

It should again be understood that several secondary identifiers may be included in the request. Thus, a content link or other such identifier may be provided in addition to a call back number, a calling number, or any combination, arrangement, or variation thereof.

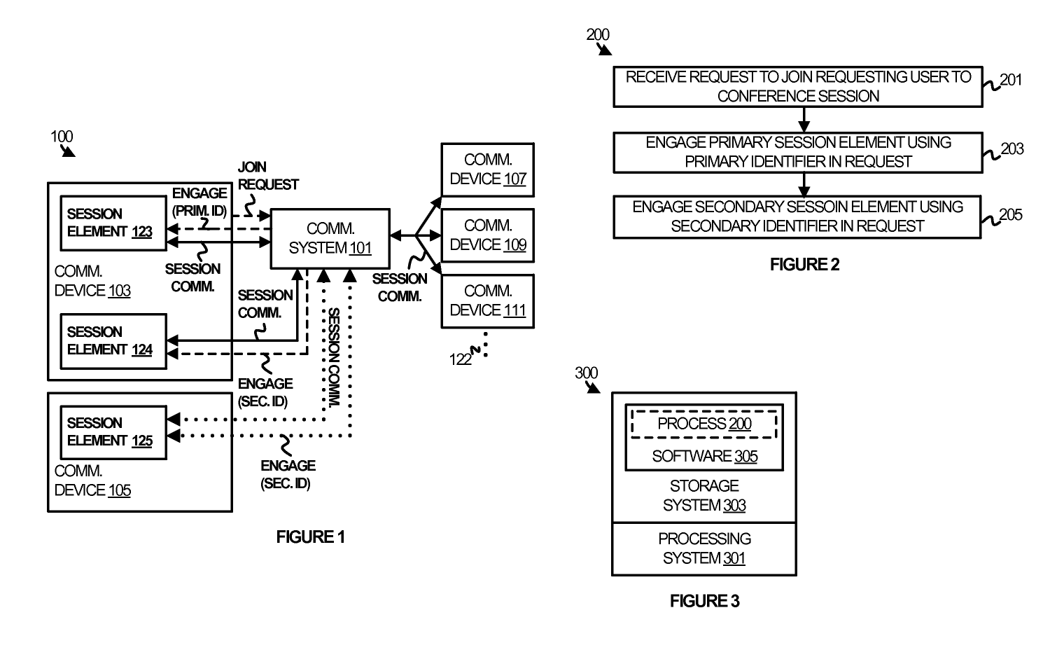

Referring now to the drawings, FIG. 1 is provided to illustrate a conferencing environment, while FIG. 2 illustrates a method of operating a communication system in the environment to provide conferencing services. FIG. 3 illustrates a computing system representative of systems suitable for implementing the communication systems and devices in the conferencing environment of FIG. 1.

In particular, conferencing environment 100 in FIG. 1 includes communication system 101. Communication system 101 is in communication with communication devices 103, 105, 107, 109, and 111. Note by ellipses 122 that additional communication devices are contemplated, as are fewer devices that those illustrated in FIG. 1. Communication system 101 may communicate with communication devices 103, 105, 107, 109, and 111 over a variety of communication links using any communication protocol or protocols suitable to facilitating conference sessions. Communication links and protocols are well known and need not be explained at length here.

Examples of communication system 101 include conference server machines having conference software running therein, gateway systems, and any arrangement, combination, or variation thereof. Example communication devices include mobile phones, personal digital assistance, tablet computers, laptop computers, notebook computers, net book computers, personal desktop computers, virtual desktop computers, and any combination, arrangement, or variation thereof.

Communication device 103 includes session element 123 and session element 124, while communication device 105 includes session element 125. Communication devices 107, 109, and 111 may also include similar session elements not discussed herein for purposes of clarity. Session elements 123, 124, and 125 may be any element capable of engaging in or being engaged in a communication session hosted by communication system 101. Examples of session elements include communication applications, such as messaging, conferencing, or calling applications, as well as any combination or variation thereof. A session element may also be some other type of function, feature, component, or components on a communication device 103 capable of engaging in a conference session. For example, the communication software, circuitry, and other elements resident on a mobile phone that allow the phone to place and receive calls may be considered a session element or session elements. Likewise, the video software, circuitry, and other elements resident on a video server that allow the video server to stream video to a destination may be considered a session element or session elements.

FIG. 2 illustrates a process 200 for operating communication system 101. In the context process 200, the general operation of conferencing environment 100 and the interaction between the elements illustrated therein will be discussed.

In operation, communication system 101 receives a request to join a requesting user to a conference session with other participants (step 201). It should be understood that one or more participants may be involved in the session. In addition, while the requesting user may be the first participant to join the session, the session may generally be considered to include additional participants.

The request to join the user to the session is generated and transferred by communication device 103. It should be understood that, even though session element 123 is ultimately engaged in the session, the join request may originate from some other element or component on communication device 103. The join request can be triggered by a number of actions, such an activation of a link contained in an invitation, an email, or some other container capable of identifying the session.

The join request identifies at least two identifiers: a primary identifier and a secondary identifier. As mention, additional identifiers are possible. In response to receiving the join request, communication system 101 engages session element 123 in the session using the primary identifier (step 203). For example, in a case where the primary identifier is a login identifier associated with the requesting user, communication system 101 determines whether the user is allowed access to the conference session based on the login identity.

Assuming access should be granted, communication system 101 establishes a communication channel with session element 123. Generally, such a channel may be used to exchange data communications between session element 123 and communication system 101 for exchange with communication device 107, 109, and 111. Depending upon the quality or reliability of the data channel, voice communications may be supported and the requesting user can exchange voice communications on the conference session with other participants.

However, in some cases the data channel may be intermittent or of such poor quality or reliability that the user prefers to access the conference session by way of a separate communication channel. Under such circumstances, the secondary identifier in the join request may be used to engage secondary element 124 (step 205). For example, the request may identify a call back number. Using the call back number, communication system 101 can initiate a call back to a communication device associated with the call back number, thereby engaging the requesting user in the conference session. It should be understood that this communication channel may be established as the only channel or in addition to the primary communication channel established using the primary identifier.

In one scenario, the communication device linked with the call back number may be communication device 103. In this case, the requesting user may be engaged in the session by way of session element 123, but also by way of session element 124 as a result of the call back to communication device 103 by communication system 101. However, the call back number may be associated with a device other than communication device 103. For instance, the call back number may be associated with communication device 105. In this scenario, the requesting user may be engaged in the conference session both by way of session element 123 on communication device 103, but also by way of session element 125 on communication device 105, yet can still be rightly identify the user to other participants involved in the conference session since both identifiers are included in the join request.

Optionally, the secondary identifier may be a caller identifier that allows communication device 103 to be identified upon calling into the conference session. This way, the requesting user can be correctly identified on a session roster presented to other participants, even though the caller identifier may not have been known or provisioned within communication system 101 prior to the call. In another variation, the secondary identifier may be a caller identifier associated with a communication device other than communication device 103. For example, the caller identifier may be associated with communication device 105 allowing the requesting user to call into the conference session using communication device 105 and still be rightly identified in the session roster.

In yet another variation, session element 125 may be a third element that is engaged in the conference session on behalf of the requesting user, in addition to session element 123 and session element 124. However, session element 125 may be engaged in addition to session element 123, while session element 124 remains unengaged. This could occur when, for example, the join request includes a login identify that links session element 123 to the session and a network address or link to video provided by session element 125.

Referring now FIG. 3, computer system 300 and the associated discussion are intended to provide a brief, general description of a computing system suitable for implementing process 200. Many other configurations of computing devices and software computing systems may be employed to implement process 200.

Computer system 300 may be any type of computing system capable of receiving a join request and responsively engaging primary and secondary session elements using primary and secondary identifiers included in the request, such as a server computer, client computer, internet appliance, or any combination or variation thereof. Indeed, computer system 300 may be implemented as a single computing system, but may also be implemented in a distributed manner across multiple computing systems. Computer system 300 is provided as an example of a general purpose computing system that, when implementing process 200, becomes a specialized system capable of supporting improved conference sessions.

Computer system 300 includes processing system 301, storage system 303, and software 305. Processing system 301 is communicatively coupled with storage system 303. Storage system 303 stores software 305 which, when executed by processing system 301, directs computer system 300 to operate as described for process 200.

Referring still to FIG. 3, processing system 301 may comprise a microprocessor and other circuitry that retrieves and executes software 305 from storage system 303. Software 305 includes process 200. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device.

Storage system 303 may comprise any storage media readable by processing system 301 and capable of storing software 305. Storage system 303 may include volatile and nonvolatile, removable and non-removable media implemented in any method or technology for storage of information, such as computer readable instructions, data structures, program modules, or other data. Storage system 303 may be implemented as a single storage device but may also be implemented across multiple storage devices or sub-systems. Storage system 303 may comprise additional elements, such as a controller, capable of communicating with processing system 301.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 305 comprises computer program instructions, such as monitoring instructions, composite health instructions, and update control instructions. Software 305 may also comprise firmware, or some other form of machine-readable processing instructions having process 200 embodied therein. Software 305 may be implemented as a single application but also as multiple applications. Software 305 may be a stand-alone application but may also be implemented within other applications distributed on multiple devices.

In general, software 305 may, when loaded into processing system 301 and executed, transform processing system 301, and computer system 300 overall, from a general-purpose computing system into a special-purpose computing system customized to receive and process a join request and responsively engage primary and secondary session elements using primary and secondary identifiers included in the request, as described for process 200 and its associated discussion.

Encoding software 305 may also transform the physical structure of storage system 303. The specific transformation of the physical structure may depend on various factors in different implementations of this description. Examples of such factors may include, but are not limited to: the technology used to implement the storage media of storage system 303, whether the computer-storage media are characterized as primary or secondary storage, and the like.

For example, if the computer-storage media are implemented as semiconductor-based memory, software 305 may transform the physical state of the semiconductor memory when the software is encoded therein. For example, software 305 may transform the state of transistors, capacitors, or other discrete circuit elements constituting the semiconductor memory.

A similar transformation may occur with respect to magnetic or optical media. Other transformations of physical media are possible without departing from the scope of the present description, with the foregoing examples provided only to facilitate this discussion.

Referring again to FIGS. 1-3, through the operation of computer system 300 employing software 305, transformations may be performed in conference environment 100. As an example, communication device 103 or 105 could be considered transformed from one state to another by the engagement of any session element within the devices with a conference session hosted by communication system 101 as a result of performing process 200. Likewise, communication system 101 or its systems and sub-systems may be considered transformed from one state to another by engaging communication devices 103 and 105 in conference sessions as a result of performing process 200.

Computer system 300 may have additional devices, features, or functionality. Computer system 300 may optionally have input devices such as a keyboard, a mouse, a voice input device, or a touch input device, and comparable input devices. Output devices such as a display, speakers, printer, and other types of output devices may also be included. Computer system 300 may also contain communication connections and devices that allow computer system 300 to communicate with other devices, such as over a wired or wireless network in a distributed computing and communication environment. These devices are well known in the art and need not be discussed at length here.

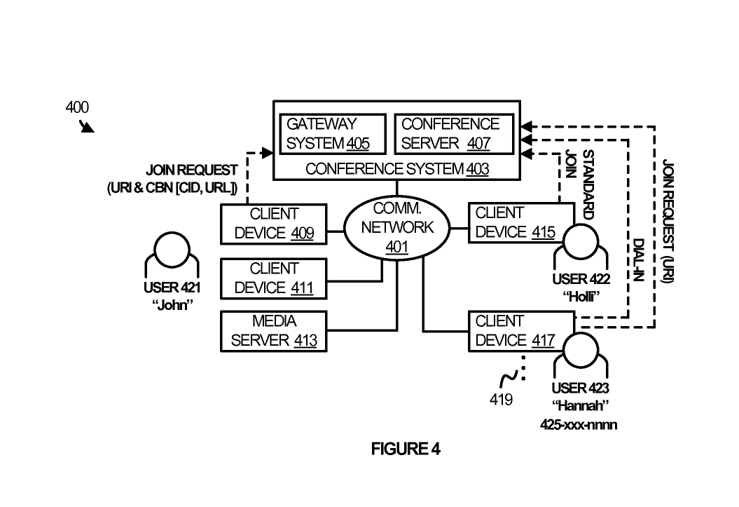

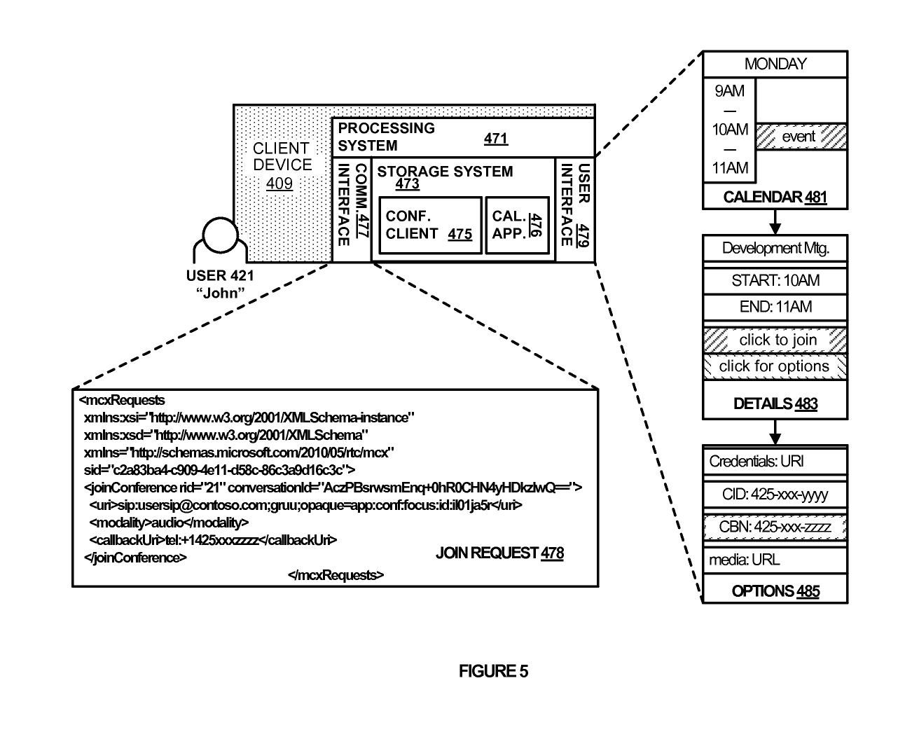

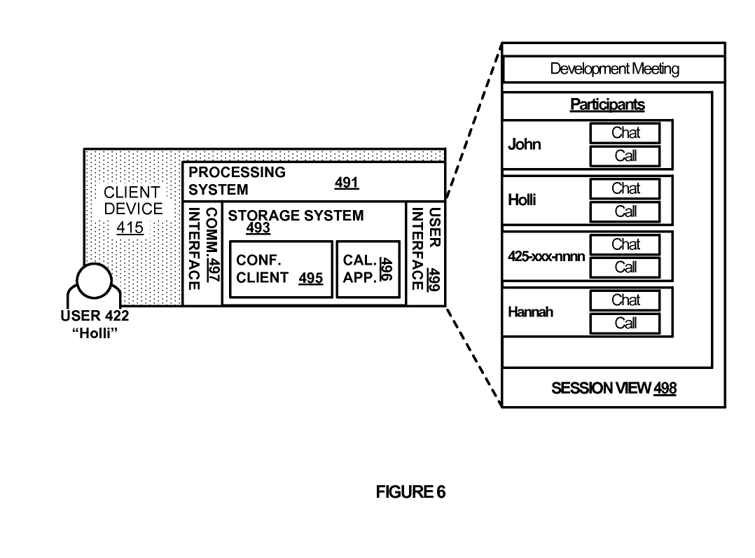

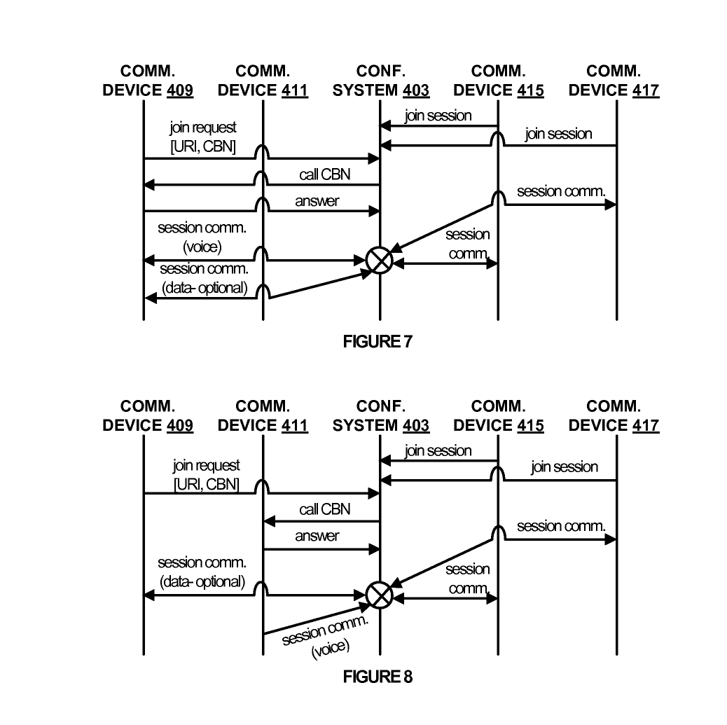

Turning now to FIGS. 4-7, another conferencing environment in illustrated in FIG. 4, while FIGS. 5-6 illustrate detailed views of client devices employed in the conferencing environment. FIGS. 7-10 illustrate several conference flow diagrams that demonstrate the interaction between the elements of the conferencing environment.

Conference environment 400 in FIG. 4 includes communication network 401, over which media server 413 and client devices 409, 411, 413, and 417 communicate with each other and with conference system 403. Communication network 401 may be any network or combination of networks capable of carrying session communications between these elements. Examples of client devices 409, 411, 413, and 417 include mobile smart phones, tablet computers, laptop computers, notebook computer, net book computers, personal desktop computer, virtual desktop computers, and any combination or variation thereof. Examples of media server 413 include video servers, music servers, web servers, and any combination or variation thereof.

Conference system 403 includes gateway system 405 and conference server 407. Conference system 403 may include other elements and is not limited to merely those disclosed herein. In addition, gateway system 405 and conference server 407 may include additional elements not disclosed herein. Conference server 407 hosts conference sessions and provides functionality and services to allow client devices to connect to and exchange communications over the conference sessions. Some client devices may communicate with conference server 407 without interacting with gateway system 405. However, gateway system 405 allows client devices to connect to conference server 407 from various networks that otherwise cannot provide more direct interaction with conference sessions and that may require services provided by gateway system 405, such as protocol or format conversion.

The following is a brief discussion of the operation of conference environment 400 in the context of a conference session between user 421 (John), user 422 (Holli), and user 423 (Hannah). In this operational example, client device 409 generates and transfers a join request to conference system 403 to join John to the conference session. The join request identifies a uniform resource identifier (URI) associated with user 421 that allows user 421 to login to the conference session. The URI may be, for example, a session initiation protocol (SIP) identifier and may be accompanied by other information, such as a password.

The join request may include additional information, such as a call back number, a caller identifier, or a uniform resource locator, or any combination or variation thereof. As will be discussed with respect to FIGS. 7-10, the call back number, caller identifier, or URL can be utilized by conference system 403 to engage client device 409 or other devices or media elements in the session on behalf of user 421.

To provide a contrasting illustration, FIG. 4 also illustrates two additional join requests generated by client devices 415 and 417 to join users 422 and 423 respectively to the conference session. In the case of client device 415, a standard join request is provided by client device 415 to login user 422 (Holli) to the conference session. It is assumed for purposes of this discussion that client device 415 enjoys a data connection sufficient to allow user 422 to communicate on the session by way of several modes of communication, such as chat and voice communication. In other words, user 422 is able to fully access all of the features of the conference session provided by conference system 403 and will be correctly identified on the session roster. User 422 may be identified and granted access to the conferences session based on a URI or some other user identifier contained in the join request.

In contrast, client device 417 accesses conference system 403 by way of two differing access mechanisms. First, client device 417 logins to the conference session using a join request that identifies user 423 based on a URI or some other suitable user identifier. As with the other users, user 423 is granted or denied access based on this identifier. Other information may also be provided and utilized in the access request, such as a password. Client device 417 can facilitate data communications over this channel to support some modes of communication for user 423, such as chat communications.

However, it is assumed for illustrative purposes that an audio channel cannot be supported over the channel established based on the join request. Thus, voice communications cannot commence between user 423 and the other participants in the conference session. As a result, user 423 via client device initiates a phone call by dialing into the conference session. In this manner, user 423 can now fully participate in the session over the previously established—but limited—data channel and the voice channel provided by way of the dial-in process.

Unfortunately, user 423 may not be correctly identified on the session roster, or may be identified in a confusing manner due to this access method. As presented to users 422 and 421, user 423 may be rightly identified as “Hannah,” but then a second and relatively anonymous identifier may be presented using the calling number associated with client device 417, or 425-xxx-nnnn in this example. Should client device 417 drop or otherwise disconnect the data channel established with the conference session, then user 423 would only be identified by the calling number.

In contrast, user 421 may be rightly identified on the roster, even though he too will connect by way of multiple communication channels. This is because the join request provided by client device 409 includes multiple identifiers, as discussed above: a URI and at least a call back number, caller identifier, or URL. This allows conference system 403 to call back to client device 409 or 411 to establish a voice channel to user 421. Variations of this implementation are possible, such as client device 409 or 411 calling into the conference server. In either case, user 421 can be identified on the roster by the association of his URI with either or both of the call back number and caller identifier. As mentioned, more detailed discussions of several implementations of this solution will be described below with respect to the flow diagrams illustrated in FIGS. 7-10.

Turning now to FIGS. 5-6, client devices 409 and 415 are illustrated in more detail to further describe some implementation aspects. Client devices 409 and 415 are generally representative of any communication devices that may be employed to facilitate conference sessions, such as mobile phone, table computers, laptop computers, net book computers, note book computers, personal desktop computers, virtual desktop computers, and any variation or combination thereof.

Client device 409 includes processing system 471, storage system 473, user interface 479, and communication interface 477. Storage system 473 stores software, such as operating system and application software, that can be executed by processing system 471 to drive client device 409 to operate as described herein. Conference client 475 and calendar application 476 are examples of application software used by user 421.

In operation, user 421 may interact with applications running on client devices 409 by way of user interface 479. In this example, user 421 accesses calendar application 476 to see a calendar view 481 his schedule for the day, Monday. As illustrated, user 421 has an event scheduled at 10:0AM. Via user interface 479, user 421 can navigate to a details view 483 that lays out details of the event.

In this example, the event is a conference session pertaining to a development meeting that starts at 10:00AM and ends at 11:00AM. Details view 483 provides user 421 with at least two options. User 421 can click or otherwise navigate to a join option that, upon selection, drives client device 409 to join the event.

By selecting this option, calendar application 476 is triggered to launch a request to a session link included in the event details. The link may directly cause client device 409 to launch conference client 475. Optionally, the link may direct client device 409 to a launch element within or external to conference system 403 that provides a launch data in return. The launch data is processed by client device 409 and triggers the launch of conference client 475. In either case, conference client 475 then generates join request 478 based on options provided in options view 485. Join request 478 is transferred by communication interface 477 to conference system 403 to join user 421 to the conference session.

Alternatively, user 421 can click on or otherwise navigate to further options. In this case, options view 485 is displayed to user 421, whereby various communication options or settings can be viewed or modified. These settings are used by conference client 475 to populate join request 478, which is ultimately used to join user 421 to conference sessions hosted by conference system 403. Join request 478 is provided in FIG. 5 merely as a sample SIP request. It should be understood that other suitable formats, data, and protocols could be used for join requests.

Options view 485 may be an integrated part of calendar application 476. However, options view 485 may also be a component of operating system software. In other words, options view 485 may be accessible to user 421 via calendar application 476, but may also be reachable through operating system screens or paths. In addition, a combination of both situations is possible. Options view 485 may also be reachable via conference client 475 or may be an integrated component of conference client 475.

Here, options view 485 provides inputs for credentials, caller identifiers, call back numbers, and media links. In this example, credentials are in the form of a URI, such as a SIP username. Other credentials may be stored therein, such as a password, or provided by user 421 at the time of logging into the conference session.

The caller identifier and call back number fields allow user 421 to specify phone numbers or other such voice identifiers that can be used by conference system 403 to link a data channel established using the URI with voice connections established to user 421. It should be understood that ten digits telephone numbers are provided herein merely for exemplary purposes. Other types of call identifiers may be used, such as SIP identifiers or handles, Skype handles, shortened telephone numbers, extended telephone numbers, and the like. The media field in options view 485 allows user 421 to provide a link to content or devices that he may wish to include in the conference session.

It should be understood that any, several, or all of the fields may be utilized by user 421 for any given session. The data provided in the fields can be persistent, but can also be provided dynamically on a per-session basis. Some of the information may be loaded automatically into the fields, such as the call back number. For example, operating system components may be programmed to load device-specific information, such as a call back number, into relevant fields. In another example, user 421 may already be logged into other services under various URIs. Those URIs may be used to populate the credentials field. Similarly, alternative types of identifiers may be used to populate the call back number field based on identifies used to login user 421 to other services. For instance, while a SIP handle may be used to populate the credentials field, a Skype handle may be used to populate the call back number field. In this manner, user 421 can access the conference session using a SIP handle, but then can exchange voice communications by way of a Skype call to conference system 403.

In FIG. 6, client device 415 is illustrated. Client device 415 includes processing system 491, storage system 493, user interface 499, and communication interface 497. Storage system 493 stores software, such as operating system and application software, that can be executed by processing system 491 to drive client device 415 to operate as described herein. Conference client 495 and calendar application 496 are examples of application software used by user 422.

Session view 498 is one exemplary view that may be displayed to user 422 while she is participating in the conference session. Session view 498 may be generated by conference client 495, but it should be understood that other applications may be capable of providing similar views. User 421 and user 423 may be presented with similar views by the conference clients running on their respective client devices.

Session view 498 displays a participant roster that describes which users are participating in the conference session. In this example, session view 498 also provides interactive elements that allow user 422 to engage any of the other participants in communication exchanges, such as by chatting or calling the other participants. Session view 498 likely contains other elements, such as a text-entry window for entering text communications that can be exchanged over the session, although additional elements are not necessary. In addition, session view 498 may provide white board or video displays. For example, some participants may be engaged in the session by way of video conferencing capabilities that allow for the transmission both of voice communications but also images of the various participants.

It can be appreciated from session view 498 that four participants are identified in the session roster: John, Holli, Hannah, and an anonymous participant identified by the phone number 425-xxx-nnnn. From the earlier discussion above it should be understood that the phone number is associated with user 423. Thus, user 423 is identified twice by her name and her phone number. This may cause confusion to other users as they may not understand that a single user is behind both identities.

In contrast, user 421 is represented by a single identity—his name. This is accomplished by way of the join request generated by communication device 409 that allows user 421 to join the session in multiple modes over multiple channels, yet still be represented under a single identity in the conference session.

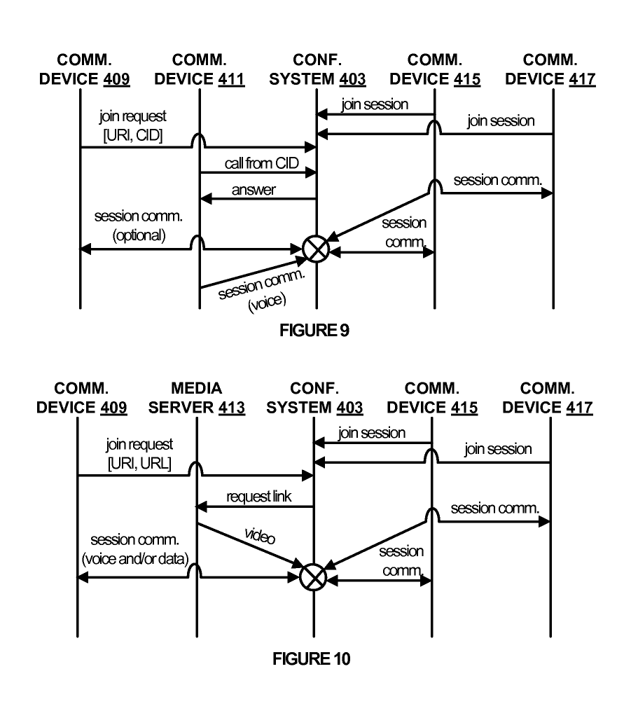

Turning now to FIGS. 7-10, several session flow diagrams are illustrated to further describe the interaction between the various elements of conference environment 400. FIG. 7 illustrates a scenario whereby user 421 joins a session via a single communication device but over two different channels. FIG. 8 illustrates a scenario whereby user 421 joins the session using two distinct communication devices. FIG. 9 illustrates another scenario whereby user 421 joins the session via two different communication devices. Lastly, FIG. 10 illustrates a scenario where user 421 arranges for video from a media server to be incorporated into the conference session.

In FIG. 7, communication device 409 generates and transfers a join request to conference system 403 to join user 421 to a conference session. In this example, the join request includes at least a URI associated with user 421 and a call back number. A substantially the same time, users 422 and 423 join the conference session by way of the mechanisms and exchanges described above.

Conference system 403 receives and processes the join request, which triggers a call back to communication device 409. In other words, the call back number in this example is associated with communication device 409. User 421 answers the call, thereby establishing a voice link with conference system 403. User 421 can then exchange at least voice communications with users 422 and 423 over the conference session.

Optionally, user 421 may also be engaged in the session over a data channel separate from the voice call. In this manner, user 421 can exchange data communications over the session, such as chat messages, documents, or any other type of data communication. Likewise, users 422 and 423 may be able to exchange data communications in addition to voice communications on the session, as described earlier. Even though user 421 is connected by way of a voice call external to the data channel over which he was registered with the session, user 421 is still correctly identified on the session roster to users 422 and 423 as discussed above with respect to FIG. 6.

In FIG. 8, communication device 409 generates a join request that identifies user 421 by a URI. The URI is processed by conference system 403 to grant user 421 with access to the conference session. At the same time, users 422 and 423 have joined the session and are able to exchange communications over the conference.

In response to the join request, conference system 403 initiates a call back to the call back number provided in the join request. In this example, the call back request is associated with communication device 411, as opposed to communication device 409. User 421 answers the call, thereby establishing a voice link with conference system 403. Optionally, user 423 may be able to exchange data communications over a data channel established between communication device 409 and conference system 403.

In this example, user 421 may provide a call back number associated with a device other than communication device 409 for a variety of reasons. For instance, communication device 411 may be a land-line telephone likely to sufficient sound quality. In another example, communication device 409 may not provide voice call capabilities. In such a case, it would be useful for user 421 to be able to provide a call back number in the join request associated with a nearby or otherwise available telephone.

In FIG. 9, communication device 409 generates a join request that identifies user 421 by a URI. The URI is processed by conference system 403 to grant user 421 with access to the conference session. At the same time, users 422 and 423 have joined the session and are able to exchange communications over the conference.

In response to the join request, conference system 403 registers a caller identifier contained in the join request. User 421, operating communication device 411, then initiates a call into the conference session whereby the caller identifier is provided. The call is answered by conference system 403, thereby establishing a voice link between communication device 411 and conference system 403. Optionally, user 423 may be able to exchange data communications over a data channel established between communication device 409 and conference system 403 in addition to the voice link via communication device 411.

In this example, user 421 may provide the caller identifier with a device other than communication device 409 for a variety of reasons. For instance, communication device 411 may be a land-line telephone likely to sufficient sound quality. In another example, communication device 409 may not provide voice call capabilities. In such a case, it would be useful for user 421 to be able to provide a caller identifier with the join request associated with a nearby or otherwise available telephone. In this manner, conference system 403 can associate the incoming call with user 421, already registered with the session by way of the URI provided in the join request.

In FIG. 10, user 421 provides a link to media in the join request. The join request is transferred by communication device 409 to conference system 403. Conference system 403 responsively retrieves video from media server 413 using the link provided in the join request.

In the meantime, users 422 and 423 may have joined the session. The video retrieved by conference system 403 can be streamed to communication devices 415 and 417 within the session. In addition, users 422 and 423 are able to view user 421 as rightly identified with both data communications exchanged via conference client 475, but also with the video downloaded from media server 413. In other words, video or other types of media sourced from a third-party server can be introduced into the conference session and presented as associated with one of the participants. In addition, the media is sourced based on a link provided in a join request.

It should be understood that, in FIG. 10, user 421 may be able to exchange voice communications either via the data channel previously established using the URI or by way of one of the alternative connection mechanisms disclosed herein. For example, in addition to streaming video on behalf of user 421 within the session, user 421 may also participate via a voice call to or from communication devices 409 and 411.

Referring back to FIG. 5, client device 409 includes processing system 471, storage system 473, communication interface 477, and user interface 479. User interface 479 may include a mouse, a voice input device, a touch input device, and other comparable input devices and associated processing elements capable of receiving user input from a user. Output devices such as a display, speakers, printer, and other types of output devices may also be included.

User interface 479 may be comprised of the aforementioned hardware elements, but some software elements may be considered a part of user interface 479. For examples, portions of operating system software may be involved in providing user interface 479. Thus, user interface 479 may be a combination of hardware and software elements as is generally well known in the art. Examples of user interfaces include graphical user interfaces involving the functional cooperation of operating system software and hardware elements, such as screen displays and user input devices, as well as other software and hardware elements.

Processing system 471 is communicatively coupled with storage system 473. Storage system 473 stores software, such as operating system and application software. Conference client 475 and calendar application 476 are examples of application software. The software may include other applications, such as productivity applications, browser applications, email applications, or any other type of application. When executed by processing system 471, the software directs client device 409 to operate as described herein.

Processing system 471 may comprise microprocessors and other circuitry that retrieve and execute software from storage system 473. Processing system 471 may be implemented within a single processing device but may also be distributed across multiple processing devices or sub-systems that cooperate in executing program instructions. Examples of processing system 471 include general purpose central processing units, application specific processors, and logic devices, as well as any other type of processing device.

Storage system 473 may comprise any storage media readable by processing system 471 and capable of storing software. Storage system 473 may include volatile and nonvolatile, removable and non-removable media implemented in any method or technology for storage of information, such as computer readable instructions, data structures, program modules, or other data. Storage system 473 may be implemented as a single storage device but may also be implemented across multiple storage devices or sub-systems. Storage system 473 may comprise additional elements, such as controllers, capable of communicating with processing system 471.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

The software stored in or on storage system 473 comprises computer program instructions, firmware, or some other form of machine-readable processing instructions. The software may be implemented as a single application but also as multiple applications, or integrated together. In general, the software, when loaded into processing system 471, drives client device 409 to operate as described herein.

Communication interface 477 may include communication connections and devices that allow for communication between client device 409 and other communication systems over communication network 401, such as conference system 403. Examples of connections and devices that together allow for inter-system communication include network interface cards, antennas, power amplifiers, RF circuitry, transceivers, and other communication circuitry. The aforementioned network, connections, and devices are well known in the art and need not be discussed at length here.

Referring back to FIG. 6, client device 415 may be considered generally analogous to client device 409 and includes elements corresponding to those of client device 409. Thus, a detailed discussion of the elements of client device 415 is refrained from for purposes of clarity and its elements may be considered structurally and operational similar to those of client device 409.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable media having stored thereon program instructions for facilitating conference sessions that, when executed by a communication system, direct the communication system to a least:
receive a request to join a requesting user to a conference session, wherein the request includes at least a primary identifier and a secondary identifier;
engage a primary session element in the conference session using the primary identifier; and
engage a secondary session element in the conference session using the secondary identifier.

2. The one or more computer readable media of claim 1 wherein the primary session element comprises a conference application residing on a first communication device and wherein the secondary session element comprises a voice call application residing on the first communication device, and wherein to engage the secondary session element, the program instructions direct the communication system to initiate a voice call to the first communication device.

3. The one or more computer readable media of claim 1 wherein the primary session element comprises a conference application residing on a first communication device and wherein the secondary session element comprises a voice call application residing on a second communication device, and wherein to engage the secondary session element, the program instructions direct the communication system to initiate a voice call to the second communication device.

4. The one or more computer readable media of claim 1 wherein the primary session element comprises a conference application residing on a first communication device and wherein the secondary session element comprises a voice call application residing on a second communication device, and wherein to engage the secondary session element, the program instructions direct the communication system to receive a voice call initiated by the second communication device.

5. The one or more computer readable media of claim 1 wherein the primary identifier comprises a uniform resource identifier (URI) used to login the primary session element to the conference session and wherein the secondary identifier comprises a call back identifier used to call the secondary session element.

6. The one or more computer readable media of claim 1 wherein primary identifier comprises a uniform resource identifier (URI) used to login the primary session element to the conference session and wherein the secondary identifier comprises a caller identifier associated with a call initiated from the secondary session element to the conference session.

7. The one or more computer readable media of claim 1 wherein the secondary session element comprises a video server and wherein to engage the video server, the third instructions direct the communication system to request video from the video server to be presented during the conference session.

8. A method of operating a conference service, the method comprising:
in a communication device, generating a request to join a requesting user to a conference session, wherein the request includes at least a primary identifier and a secondary identifier, and transferring the request for delivery to a conference server; and
in the conference server, receiving the request and responsively registering the user with the conference session using the primary identifier and engaging the user in the conference session using the secondary identifier.

9. The method of claim 8 wherein generating the request occurs in a conference client running on the communication device and wherein engaging the requesting user comprises initiating a voice call to the communication device.

10. The method of claim 8 wherein generating the request occurs in a conference client running on the communication device and wherein engaging the requesting user comprises initiating a voice call to another communication device.

11. The method of claim 8 wherein generating the request occurs in a conference client running on the communication device and wherein engaging the requesting user comprises initiating a voice call from communication device to the conference server.

12. The method of claim 8 wherein the primary identifier comprises a uniform resource identifier (URI) used to login the requesting user to the conference session and wherein the secondary identifier comprises a call back identifier used to call the communication device.

13. The method of claim 8 wherein primary identifier comprises a uniform resource identifier (URI) used to login the requesting user to the conference session and wherein the secondary identifier comprises a caller identifier associated with a call to the conference server.

14. The method of claim 8 wherein the secondary identifier comprises a uniform resource locator (URL) associated with video stored on a video server and wherein engaging the user with the conference session using the secondary identifier comprises requesting the video from the video server using the URL and presenting the video in the conference session.

15. One or more computer readable media having stored thereon program instructions for facilitating conference sessions, the program instructions comprising:
client instructions that, when executed by a communication device, direct the communication device to generate a request to join a requesting user to a conference session, wherein the request includes at least a primary identifier and a secondary identifier, and transfer the request for delivery to a conference server; and
server instructions that, when executed by the conference server, direct the conference server to receive the request and responsively register the user with the conference session using the primary identifier and initiate a call using the secondary identifier to engage the user in the conference session.

16. The one or more computer readable media of claim 15 wherein the call comprises a voice call to the communication device.

17. The one or more computer readable media of claim 15 wherein the call comprises a voice call to another communication device.

18. The one or more computer readable media of claim 15 wherein the call comprises a voice call placed from the communication device into the conference session.

19. The one or more computer readable media of claim 15 wherein the primary identifier comprises a uniform resource identifier (URI) used to login the requesting user to the conference session and wherein the secondary identifier comprises a call back identifier used to call the communication device.

20. The one or more computer readable media of claim 15 wherein the server instructions, when executed by the conference server, further direct the conference server to request video from a media server using a uniform resource locator (URL) identified in the request and present the video in the conference session.
